(19) United States
(12) Patent Application Publication
(10) Pub. No.: US 2011/0094844 A1
(43) Pub. Date: Apr. 28, 2011

(54) ACTUATOR SYSTEM FOR A DOUBLE CLUTCH, DOUBLE CLUTCH SYSTEM AND MOTOR VEHICLE WITH A DOUBLE CLUTCH SYSTEM

(75) Inventor: Sascha Schlieker, Frankfurt (DE)

(73) Assignee: GM GLOBAL TECHNOLOGY OPERATIONS, INC., Detroit, MI (US)

(21) Appl. No.: 12/909,662

(22) Filed: Oct. 21, 2010

(30) Foreign Application Priority Data
Oct. 22, 2009 (DE) 102009050333.1

(51) Int. Cl. F16D 28/00

(52) U.S. Cl. 192/48.2; 192/84.1

(57) ABSTRACT

An actuator system for a clutch includes, but is not limited to a threaded hollow cylinder connected to the clutch bell in a rotationally fixed manner, which on its outside and on its inside comprises a thread and furthermore a first hollow cylinder for actuating a first release bearing, wherein the first hollow cylinder comprises an internal thread which is in engagement with the external thread of the threaded hollow cylinder and a second hollow cylinder for actuating a second release bearing. The second hollow cylinder comprises an external thread which is in engagement with the internal thread of the threaded hollow cylinder Furthermore, the actuator system comprises at least one electric motor by means of which the first hollow cylinder and the second hollow cylinder via a transmission each can be displaced along their longitudinal axis on the threaded hollow cylinder.

### CROSS-REFERENCE TO RELATED APPLICATION

This application claims priority to German Patent Application No. 102009050333.1, filed Oct. 22, 2009, which is incorporated herein by reference in its entirety.

### TECHNICAL FIELD

The invention relates to an actuator system for a double clutch, a double clutch system, and a motor vehicle with a double clutch system.

### BACKGROUND

Double clutch systems are mostly provided with electrohydraulic, sometimes however also with electromechanical disengagement or actuator systems.

DE 10 2005 025 266 A1 discloses an electromechanically actuated double clutch. Double clutches are also known whose clutch release bearings are actuated by means of an electrically actuated lever. From DE 100 64 459 A1 an electrohydraulic double clutch with an actuation is known, wherein two tubular bodies are arranged coaxially about the driven shafts.

Accordingly, at least one object is to state an actuator system for a double clutch which can be embodied particularly easily and in a space-saving manner yet is robust and reliable.

### SUMMARY

An actuator system for a clutch comprises a threaded hollow cylinder connected to the clutch bell in a rotationally fixed manner, which has a thread on its outside and on its inside. Furthermore it comprises a first hollow cylinder for actuating a first release bearing, wherein the hollow cylinder has an internal thread which is in engagement with the external thread of the threaded hollow cylinder. Furthermore, it comprises a second hollow cylinder for actuating a second release bearing, wherein the hollow cylinder has an external thread which is in engagement with the internal thread of the threaded hollow cylinder. By means of at least one electric motor the first hollow cylinder and the second hollow cylinder can be displaced along their longitudinal axis on the threaded hollow cylinder via a transmission each.

In an embodiment, two electric motors are provided, namely a first electric motor assigned to the first hollow cylinder and a second electric motor assigned to the second hollow cylinder. In this case, each of the two hollow cylinders is therefore actuated by its own electric motor. Here, a transmission each is practically also provided for each electric motor or hollow cylinder.

In an embodiment, the threaded hollow cylinder, the first hollow cylinder and the second hollow cylinder are arranged in the interior of the clutch bell and the first electric motor and the second electric motor outside the clutch bell. In this manner, the space available in the clutch bell can be optimally utilized for accommodating the actuator system, while accommodating the electric motors outside allows more freedom for their positioning and also easier maintenance and repair if required because of their better accessibility.

In an embodiment the transmissions are each designed as gear transmissions and the first hollow cylinder and the second hollow cylinders each comprise a gear rim on their outside in which at least one gear of the gear transmission engages. To this end, the first hollow cylinder and the threaded hollow cylinder can each have a clearance through which the gear rim is accessible to the gear transmission on the outside of the second hollow cylinder.

Depending on the pursuit safety strategy, the threads of the threaded hollow cylinder, of the first hollow cylinder and of the second hollow cylinder can be designed in a manner retained by friction. In the event of a power failure the clutch then remains closed, but no continuous electrification of the electric motor is necessary in operation. Alternatively, the electric motors can also be designed in a manner retained by friction. The threaded hollow cylinder, the first hollow cylinder and the second hollow cylinder are advantageously formed of metal, more preferably of stainless steel, aluminum or an aluminum alloy.

A double clutch system according to the invention comprises two clutch mechanisms connecting a driving shaft with two coaxial driven shafts and two release bearings with an actuator system according to the invention. Here, in an embodiment, the threaded hollow cylinder, the first hollow cylinder and the second hollow cylinder are arranged coaxially about the two driven shafts. The actuator system according to the invention is particularly suitable for use in dry double clutches.

It has the advantage that it has particularly simply constructed components and is thus cost-effective and robust. In addition, it has very good efficiency since the electric energy is directly converted into the disengagement movement. No conversion such as into hydraulic energy connected in-between is required. Furthermore, there is great freedom in the configuration of the transmissions, particularly through size and quantity of the gears and number and type of teeth and in the choice of the electric motors so that flexible adaptation to the existing space is easily possible. The suitable choice of transmission ratio of the transmission allows selecting a particularly small electric motor.

### BRIEF DESCRIPTION OF THE DRAWINGS

The present invention will hereinafter be described in conjunction with the following drawing figures, wherein like numerals denote like elements, and.

FIG. 1 schematically shows a cross section through an actuator system according to an embodiment of the invention;

FIG. 2 schematically shows a perspective view of the actuator system according to FIG. 1; and

FIG. 3 schematically shows a further perspective view of the actuator system according to FIG. 1.

### DETAILED DESCRIPTION

The following detailed description is merely exemplary in nature and is not intended to limit application and uses. Furthermore, there is no intention to be bound by any theory presented in the preceding background or summary or the following detailed description.

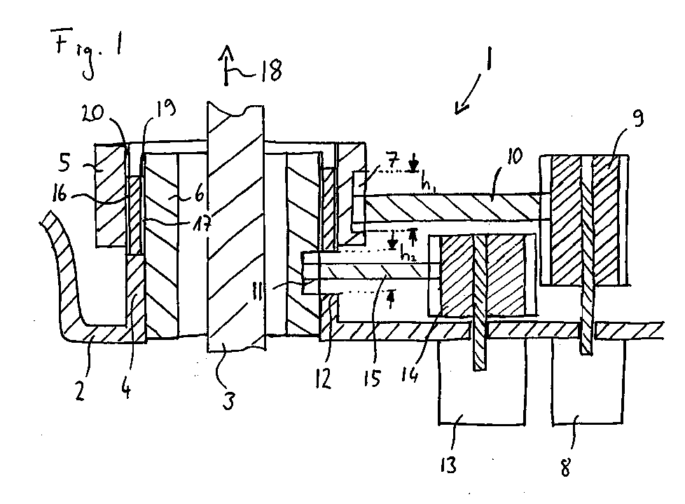

The actuator system 1 according to FIG. 1 is arranged within a clutch bell 2 and concentrically about a driven shaft 3, wherein the driven shaft 3 in the exemplary embodiment shown is formed of the hollow shaft and the solid shaft of a double clutch transmission arranged therein. The actuator system 1 comprises a threaded hollow cylinder 4 which is connected to the bottom of the clutch bell 2 in a rotationally fixed manner and which on its outside has an external thread 16 and on it's inside an internal thread 17. In the embodiment shown the threaded hollow cylinder 4 is embodied as casting unitarily with the clutch bell 2.

Outside and coaxially with the threaded hollow cylinder 4, a first hollow cylinder 5 is arranged, which on its inside has an internal thread 20 which is in engagement with the external thread 16 of the threaded hollow cylinder 4. Within the and likewise coaxially with the threaded hollow cylinder 4 a second hollow cylinder 6 is arranged, which on its inside has an external thread 19 which is in engagement with the internal thread 17 of the threaded hollow cylinder 4. The first hollow cylinder 5 on a region of its outside comprises a gear rim 7. A first electric motor 8 is arranged below the clutch bell 2 and drives the first hollow cylinder 5 via a thread comprising a first gear 9 and a second gear 10, in whose gear rim 7 the second gear 10 engages. In the same manner, a second electric motor drives the second hollow cylinder 6 via a thread comprising a third gear 14 and a fourth gear 15, in whose gear rim 11 the fourth gear 15 engages.

In order to make the gear rim 11 of the second hollow cylinder 6 accessible to the transmission, a clearance 12 in the threaded hollow cylinder 4 is provided and the first hollow cylinder 5 is attached only above the clearance 12. Alternatively, the first hollow cylinder 5 can likewise comprise a clearance. In order to open the clutch of the first or the second part transmission of the double clutch transmission, the first hollow cylinder 5 or the second hollow cylinder 6 disengages in the direction of the arrow 18 depending on the selected gear.

If the first hollow cylinder 5 is to disengage, the first electric motor 8 applies a rotational moment on the first hollow cylinder 5 via the first gear 9 and the second gear 10, which because of the guidance through the internal thread 20 in engagement with the external thread 16 of the threaded hollow cylinder 4 moves in the direction of the arrow 18. Similarly, transmission of the rotational moment from the second electric motor 13 via the third gear 14 and the fourth gear 15 to the second hollow cylinder 6 takes place when disengaging the second hollow cylinder 6, which because of the guidance through the external thread 19 that is in engagement with the internal thread 17 of the threaded hollow cylinder 4 moves in the direction of the arrow 18. For engaging, the movement in each case takes place in reverse direction. Here the height h1 of the gear rim 7 is selected in such a size that the stroke during disengagement and wear of the clutch are already taken into account. The same applies to the height h2 of the gear rim 11 since during clutching the second gear 10 and the gear rim 7 or the fourth gear 15 and the gear rim 11 axially move past each other.

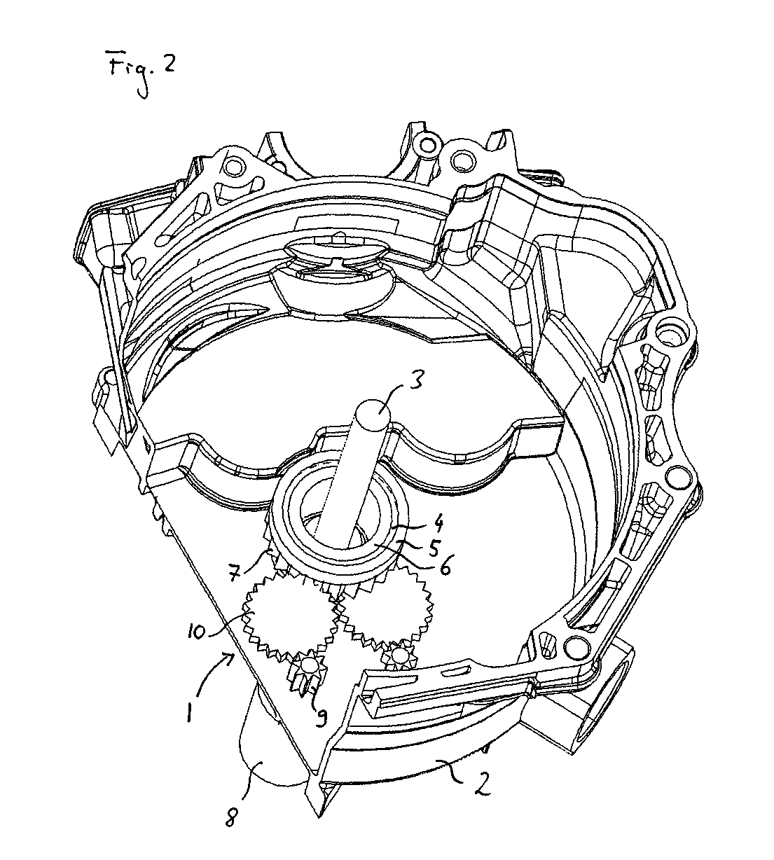

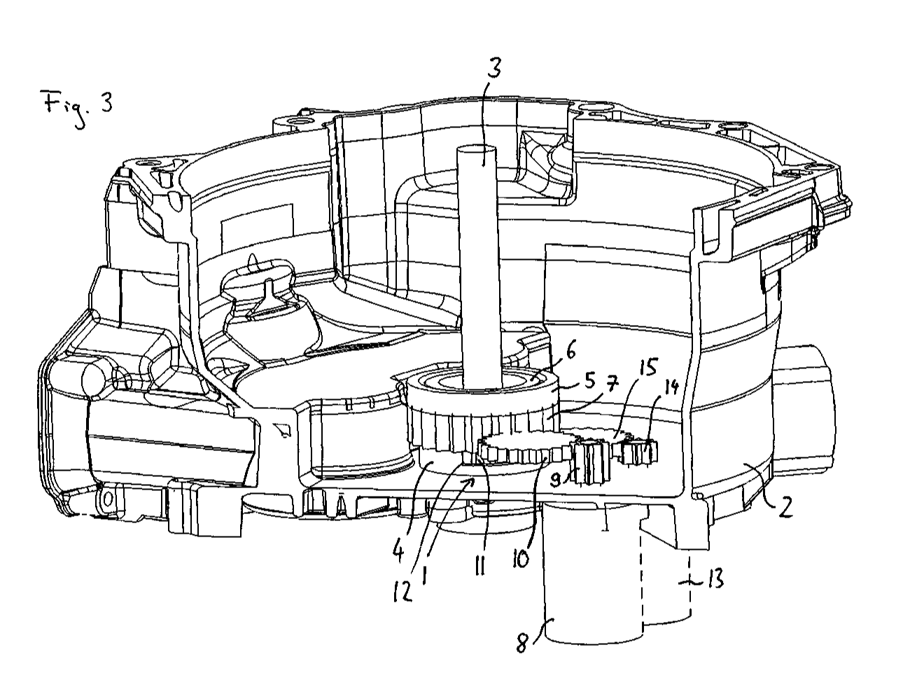

FIG. 2 and FIG. 3 show the arrangement of the actuator system 1 within the clutch bell 2 in perspective view, wherein however the electric motors 8, 13 are arranged outside. In order to adjust the actuator system 1 a suitable transmission ratio of the gear transmission is selected which for example can be matched to electric motors of small design. A further selectable parameter of the actuator system 1 is the pitch of the thread 16, 17, 19, 20 used.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. An actuator system for a clutch, comprising:
a clutch bell;
a threaded hollow cylinder connected to the clutch bell in a rotationally fixed manner that on an outside and on an inside has a thread;
a first hollow cylinder adapted to actuate a first release bearing, the first hollow cylinder comprising an internal thread in engagement with an external thread of the threaded hollow cylinder;
a second hollow cylinder adapted to actuate a second release bearing, the second hollow cylinder comprising an second external thread in engagement with an internal thread of the threaded hollow cylinder; and
a first electric motor in which via a transmission for each of the first hollow cylinder and the second hollow cylinder are displaceable along a longitudinal axis on the threaded hollow cylinder.

2. The actuator system according to claim 1, further comprising a second electric motor, wherein said first electric motor is assigned to the first hollow cylinder and the second electric motor is assigned to the second hollow cylinder.

3. The actuator system according to claim 2, wherein the threaded hollow cylinder, the first hollow cylinder, and the second hollow cylinder are arranged in a clutch bell interior of the clutch bell and the first electric motor and the second electric motor are arranged outside the clutch bell.

4. The actuator system according to claim 1, wherein the transmission for each of the first hollow cylinder and the second hollow cylinder are designed as a gear transmissions, and the first hollow cylinder and the second hollow cylinder on an outside each comprise a gear rim in which a gear of the gear transmission engages.

5. The actuator system according to claim 4, wherein the threaded hollow cylinder has a clearance through which the gear rim on the outside of the second hollow cylinder is accessible to the gear transmission.

6. The actuator system according to claim 1, wherein the thread of the threaded hollow cylinder is retained by friction.

7. The actuator system according to claim 1, wherein the thread of the first hollow cylinder is retained by friction.

8. The actuator system according to claim 1, wherein the thread of the second hollow cylinder is retained by friction.

9. The actuator system according to claim 1, wherein the first electric motor is retained by friction.

10. The actuator system according to claim 1, wherein at least one of the threaded hollow cylinder, the first hollow cylinder, or the second hollow cylinder is formed of metal.

11. The actuator system according to claim 1, wherein at least one of the threaded hollow cylinder, the first hollow cylinder, or the second hollow cylinder is formed of stainless steel.

12. The actuator system according to claim 1, wherein at least one of the threaded hollow cylinder, the first hollow cylinder, or the second hollow cylinder is formed of aluminum.

13. The actuator system according to claim 1, wherein at least one of the threaded hollow cylinder, the first hollow cylinder, or the second hollow cylinder is formed of an aluminum alloy.

14. A double clutch system, comprising:
a driving shaft;
at least two coaxial driven shafts;
at least two clutch mechanisms connecting the driving shaft with the at least two coaxial driven shafts; and
at least two release bearings with an actuator system, the actuator system comprising:
a clutch bell;
a threaded hollow cylinder connected to the clutch bell in a rotationally fixed manner that on an outside and on an inside has a thread;
a first hollow cylinder adapted to actuate a first release bearing, the first hollow cylinder comprising an internal thread in engagement with an external thread of the threaded hollow cylinder;
a second hollow cylinder adapted to actuate a second release bearing, the second hollow cylinder comprising an second external thread in engagement with an internal thread of the threaded hollow cylinder; and
a first electric motor in which via a transmission for each of the first hollow cylinder and the second hollow cylinder are displaceable along a longitudinal axis on the threaded hollow cylinder.

15. The double clutch system according to claim 14, wherein the threaded hollow cylinder, the first hollow cylinder and the second hollow cylinder are arranged coaxially about the at least two coaxial driven shafts.

16. The double clutch system according to claim 14, further comprising a second electric motor, wherein said first electric motor is assigned to the first hollow cylinder and the second electric motor is assigned to the second hollow cylinder.

17. The double clutch system according to claim 16, wherein the threaded hollow cylinder, the first hollow cylinder, and the second hollow cylinder are arranged in a clutch bell interior of the clutch bell and the first electric motor and the second electric motor are arranged outside the clutch bell.

18. The double clutch system according to claim 14, wherein the transmission for each of the first hollow cylinder and the second hollow cylinder are designed as a gear transmissions, and the first hollow cylinder and the second hollow cylinder on an outside each comprise a gear rim in which a gear of the gear transmission engages.

19. The double clutch system according to claim 16, wherein the threaded hollow cylinder has a clearance through which a gear rim on the outside of the second hollow cylinder is accessible to the gear transmission.

20. The double clutch system according to claim 14, wherein the thread of the threaded hollow cylinder is retained by friction.
